(19) United States
(12) Patent Application Publication
(10) Pub. No.: US 2024/0260005 A1
(43) Pub. Date: Aug. 1, 2024

(54) UPLINK DATA TRANSMISSION METHOD OF ZERO-POWER-CONSUMPTION TERMINAL AND COMMUNICATION DEVICE

(71) Applicant: GUANGDONG OPPO MOBILE TELECOMMUNICATIONS CORP., LTD., Dongguan (CN)

(72) Inventors: Xue LIN, Dongguan (CN); Shukun WANG, Dongguan (CN)

(73) Assignee: GUANGDONG OPPO MOBILE TELECOMMUNICATIONS CORP., LTD., Dongguan (CN)

(21) Appl. No.: 18/629,903

(22) Filed: Apr. 8, 2024

Related U.S. Application Data
(63) Continuation of application No. PCT/CN2021/122837, filed on Oct. 9, 2021.

(51) Int. Cl. H04W 72/02; H04W 72/51

(52) U.S. Cl. CPC H04W 72/02; H04W 72/51

(57) ABSTRACT

An uplink data transmission method of a zero-power-consumption terminal and a communication device are provided. The uplink data transmission method includes selecting a first uplink resource from uplink resources configured by a network device, in response to the zero-power-consumption terminal meeting a trigger condition; and transmitting uplink data to the network device through the first uplink resource.

### CROSS REFERENCE TO RELATED APPLICATION

The present disclosure is a continuation of International Patent Application No. PCT/CN2021/122837, filed Oct. 9, 2021, the contents of which is herein incorporated by reference in its entirety.

### TECHNICAL FIELD

The present disclosure relates to the field of zero-power-consumption communication, in particular to an uplink data transmission method of a zero-power-consumption terminal and a communication device.

### BACKGROUND OF THE RELATED ART

Zero-power-consumption communication adopts a power harvesting technology and a back scattering communication technology. A back scattering mode may implement signal transmission without power of a zero-power-consumption terminal itself.

The zero-power-consumption terminal harvests power by harvesting a radio wave, and enters into a working state. In case where a network device transmits a trigger instruction to the zero-power-consumption terminal, the zero-power-consumption terminal transmits uplink data carrying a terminal identifier through an uplink resource, and the uplink data is served as a response to the trigger instruction.

In case where multiple zero-power-consumption terminals receive the trigger instruction at the same time, the multiple zero-power-consumption terminals transmits the above uplink data through the same uplink resource, thus causing uplink conflict phenomenon.

### SUMMARY

According to a first aspect in some embodiments of the present disclosure, an uplink data transmission method of a zero-power-consumption terminal is provided and includes: selecting a first uplink resource from uplink resources configured by a network device, in response to the zero-power-consumption terminal meeting a trigger condition; and transmitting uplink data to the network device through the first uplink resource.

According to a second aspect in some embodiments of the present disclosure, a communication device is provided and includes a processor and a memory; the memory stores at least one computer program, and the processor is configured to execute the at least one computer program to implement a method, and the method includes: selecting a first uplink resource from uplink resources configured by a network device, in response to the zero-power-consumption terminal meeting a trigger condition; and transmitting uplink data to the network device through the first uplink resource.

According to a third aspect in some embodiments of the present disclosure, a communication device is provided and includes a processor and a memory. The memory stores at least one program, and the processor is configured to execute the at least one program to implement a method, and the method includes: receiving, by a network device, uplink data transmitted by the zero-power-consumption terminal through a first uplink resource; the first uplink resource is selected from the uplink resources configured by the network device, in response to the zero-power-consumption terminal meeting a trigger condition.

### BRIEF DESCRIPTION OF THE DRAWINGS

In order to make the technical solutions described in embodiments of the present disclosure more clearly, the drawings used for description of some embodiments are described. Apparently, the drawings in the following description only illustrate some embodiments of the present disclosure. For those skilled in the art, other drawings may be acquired according to the drawings without any creative work.

FIG. 1 is a schematic diagram of a zero-power-consumption communication system according to an embodiment of the present disclosure.

FIG. 2 is a schematic diagram of a principle of radio frequency power harvesting.

FIG. 3 is a schematic diagram of a principle of back scattering communication process.

FIG. 4 is a schematic diagram of a principle of a resistance load modulation.

FIG. 5 is a schematic diagram of coding modes.

FIG. 6 is a schematic diagram of a zero-power-consumption communication system according to an embodiment of the present disclosure.

FIG. 7 is a schematic diagram of a zero-power-consumption communication system according to an embodiment of the present disclosure.

FIG. 8 is a flowchart of an uplink data transmission method of a zero-power-consumption terminal according to an embodiment of the present disclosure.

FIG. 9 is a flowchart of an uplink data transmission method of a zero-power-consumption terminal according to an embodiment of the present disclosure.

FIG. 10 is a flowchart of an uplink data transmission method of a zero-power-consumption terminal according to an embodiment of the present disclosure.

FIG. 11 is a flowchart of an uplink data receiving method of a network device according to an embodiment of the present disclosure.

FIG. 12 is a flowchart of an uplink data receiving method of a network device according to an embodiment of the present disclosure.

FIG. 13 is a flowchart of an uplink data receiving method of a network device according to an embodiment of the present disclosure.

FIG. 14 is a flowchart of an uplink data receiving method of a network device according to an embodiment of the present disclosure.

FIG. 15 is a block diagram of an uplink data transmission apparatus of a zero-power-consumption terminal according to an embodiment of the present disclosure.

FIG. 16 is a block diagram of an uplink data receiving apparatus of a network device according to an embodiment of the present disclosure.

FIG. 17 is a structural schematic diagram of a communication device according to an embodiment of the present disclosure.

### DETAILED DESCRIPTIONS

In order to make the purpose, technical solutions, and technical effect of the present disclosure more clearly, some implementations of the present disclosure will be further described in detail below in combination with the drawings. Some exemplary embodiments will be described in detail, and examples of exemplary embodiments the are shown in the drawings. When the following description involves the drawings, unless otherwise indicated, the same serial number in different drawings indicates the same or similar elements. The implementations described in the following exemplary embodiments do not represent all embodiments consistent with the present disclosure. On the contrary, they are only examples of apparatuses and methods consistent with some aspects of the present disclosure as detailed in the appended claims. Network architectures and service scenarios described in some embodiments of the present disclosure are intended to more clearly illustrate the technical solutions of the embodiments of the present disclosure, and do not constitute a limitation of the technical solutions provided in the embodiments of the present disclosure. As those skilled in the art may know, with the evolution of the network architecture and the emergence of new service scenarios, the technical solutions provided in the embodiments of the present disclosure are applicable for similar technical problems. The terms used in the embodiments of the present disclosure are only for the purpose of describing the embodiments, and are not intended to limit the present disclosure. Singular forms of “a” and “the” used in the embodiments of the present disclosure and the appended claims are intended to include plural forms, unless the context clearly indicates other meanings. It should be understood that the term “and/or” herein refers to and includes any or all possible combinations of one or more associated listed items.

It should be understood that although the terms “first” and “second”, etc. may be configured to describe various information in some embodiments of the present disclosure, such information should not be limited to be described through these terms. These terms are only configured to distinguish the same type of information from each other. For example, without departing from the scope of the present disclosure, a first parameter may also be called a second parameter, similarly, the second parameter may also be called the first parameter. Depending on the context, the word “if” may be interpreted as “when” or “in response to”.

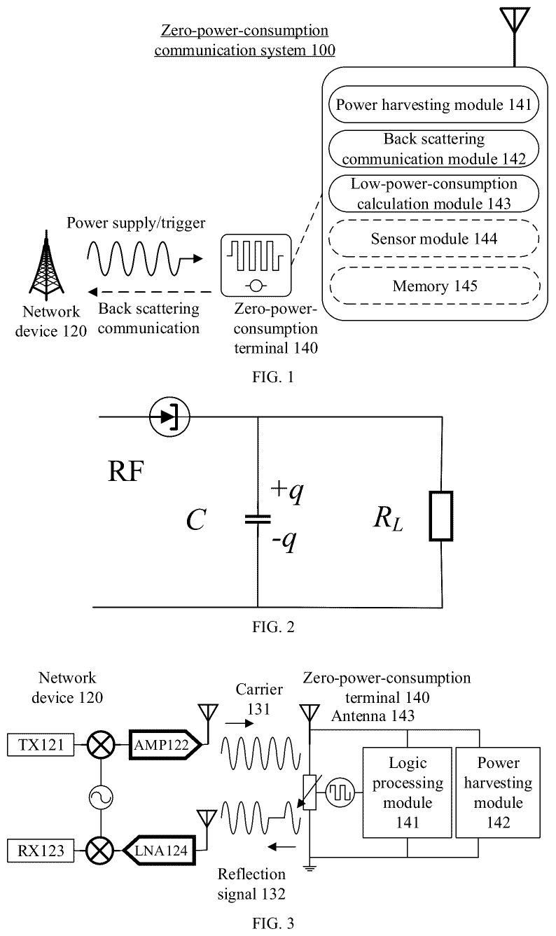

FIG. 1 shows a schematic diagram of a zero-power-consumption communication system 100, which includes a network device 120 and a zero-power-consumption terminal 140.

The network device 120 is configured to transmit a wireless power supply signal and a downlink communication signal, and is configured to receive a back scattering signal of the zero-power-consumption terminal. The zero-power-consumption terminal 140 includes a power harvesting module 141, a back scattering communication module 142, and a low-power-consumption calculation module 143. The power harvesting module 141 may harvest power carried by a radio wave in the space, and the power may be configured to drive the low-power-consumption calculation module 143 of the zero-power-consumption terminal 140 and implement the back scattering communication. After the zero-power-consumption terminal 140 obtains the power, it may receive the control signaling and transmit the data to the network device 120 based on the control signaling through the backward scattering way. The transmitted data may come from data stored in the zero-power-consumption terminal itself (such as identity marks or pre-written information, for example, the production date of goods, brand, and manufacturer, etc.).

The zero-power-consumption terminal 140 may include a sensor module 144 and a memory 145. The sensor module 144 may include all kinds of sensors, and the zero-power-consumption terminal 140 may report data harvested by the all kinds of sensors based on a zero-power-consumption mechanism. The memory 145 is configured to store some basic information (such as goods identifier, etc.) or obtain sensing data such as ambient temperature and ambient humidity, etc.

The zero-power-consumption terminal itself does not need a battery, while the use of the low-power-consumption calculation module may implement simple signal demodulation, decoding or encoding, modulation, and other simple computing work, therefore a zero-power-consumption module only requires minimal hardware design, making the zero-power-consumption device very low cost and small size.

Next, a key technology of zero-power-consumption communication is introduced.

### Radio Frequency Power Harvesting

FIG. 2 shows a schematic diagram of a principle of radio frequency (RF) power harvesting. The RF power harvesting is based on the principle of electromagnetic induction. A RF module implements the harvesting of space electromagnetic wave power and obtains the power required to drive the zero-power-consumption terminal through electromagnetic induction and being connected to a capacitor C and a load resistor R_{L} in parallel. For example, the power is configured to drive a low-power-consumption demodulation module, a modulation module, a sensor, and memory reading. Therefore, the zero-power-consumption terminal does not need a traditional battery.

### Back Scattering Communication

FIG. 3 shows a schematic diagram of a principle of back scattering communication process. The zero-power-consumption terminal 140 receives a wireless signal carrier 131 transmitted by a transmission module (Transmit, TX) 121 of the network device 120 through an asynchronous mapping procedure (AMP) 122, modulates the wireless signal carrier 131, loads information to be transmitted through a logic processing module 141, and harvest the radio frequency power through a power harvesting module 142. The zero-power-consumption terminal 140 to radiate a modulated reflection signal 132 through an antenna 143. This information transmission process is called the back scattering communication. A receiving module (Receive, RX) 123 of the network device 120 receives a modulated reflection signal 132 through a low noise amplifier (LNA) 124. The back scattering and load modulation functions are inseparable. The load modulation completes a modulation process by adjusting and controlling an electrical parameter of an oscillation loop of the zero-power-consumption terminal 140 according to a beat of a data stream to change a size of a parameter such an impedance of an electronic label.

A load modulation technology includes resistance load modulation and capacitance load modulation. FIG. 4 shows a schematic diagram of a principle of a resistance load modulation. In the resistance load modulation, a load resistor R_{L} is connected in parallel with a third resistor R₃, and on-off is implemented based on a switch S controlled by binary coding. On-off of the third resistor R₃ may lead to change of a voltage on the circuit. The load resistor R_{L} is connected in parallel with a first capacitor C₁, the load resistor R_{L} is connected in series with a second resistor R₂, and the second resistor R₂ is connected in series with a first inductor L₁. The first inductor L₁ is coupled with a second inductor L₂, and the second inductor L₂ is connected in series with a second capacitor C₂. In this way, amplitude shift keying (ASK) may be implemented, that is, modulation and transmission of a signal may be implemented by adjusting an amplitude of the back scattering signal of the zero-power-consumption terminal. Similarly, in the capacitance load modulation, On-off a capacitor may implements a change of a circuit resonance frequency and frequency shift keying (FSK) modulation, that is, modulation and transmission of the signal may be implemented by adjusting an working frequency of the back scattering signal of the zero-power-consumption terminal.

The zero-power-consumption terminal modulates an incoming wave signal through the load modulation, so as to implement the back scattering communication process. The zero-power-consumption terminal has following significant advantages. The terminal does not actively transmit a signal, so that it does not need a complex RF link, such as a power amplifier (PA) and a RF filter, etc. The terminal does not need to actively generate a high-frequency signal, so that it does not need a high-frequency crystal oscillator. Transmission of a terminal signal does not need to consume the terminal's own power through the back scattering communication.

Next, a coding mode of the zero-power-consumption communication is introduced.

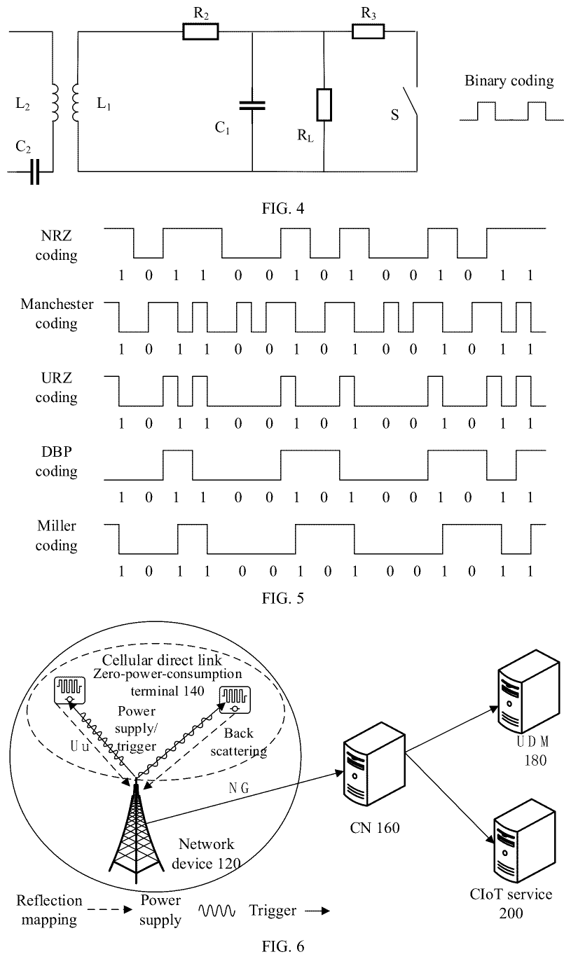

FIG. 5 shows a schematic diagram of coding modes. Data transmitted by the electronic tag may represent binary “1” and “0” in different forms of code. A RF identification (RFID) system is usually adopted one of the following coding modes: Not Return to Zero (NRZ) coding, Manchester coding, Unipolar RZ (URZ) coding, differential Binary Phase (DBP) coding, Miller coding, and Differential coding. That is, 0 and 1 are represented by different pulse signals.

NRZ coding. In NRZ coding, binary “1” is configured to represent a high level, and binary “0” is configured to represent a low level. NRZ coding in FIG. 5 shows a schematic diagram of coding binary data “101100101001011” by using the NRZ mode.

Manchester coding. Manchester coding is also called Split-Phase Coding. In Manchester coding, a binary value is represented by a change (rising or falling) of a level at half a bit cycle within the bit length. A negative jump at the half a bit cycle represents binary “1”, and the positive jump at the half a bit cycle represents binary “0”. An error of data transmission means that when data bits simultaneously transmitted by multiple electronic tags have different values, a received rising edge and a received falling edge cancel each other, resulting in uninterrupted carrier signals throughout the bit length. Manchester code cannot exist an unchanged state within the bit length. A reader/writer may use this error to determine a location where a collision occurs. Manchester coding is conducive to finding errors in data transmission. When carrier load modulation or back scattering modulation is used, Manchester coding is usually configured for data transmission from an electronic tag to a reader/writer. Manchester coding in FIG. 5 shows a schematic diagram of coding binary data “101100101001011” by using the Manchester mode.

URZ coding. A high level of URZ coding in a first half a bit cycle represents binary “1”, while a low level signal that lasts throughout the bit cycle represents binary “0”. URZ coding in FIG. 5 shows a schematic diagram of coding binary data “101100101001011” by using the URZ mode.

DBP coding. Any edge of DBP coding in half a bit cycle represents binary “0”, and no edge represents binary “1”. In addition, at the beginning of each bit cycle, the level is inverted. For a receiver, a bit beat is easy to reconstruct. DBP coding in FIG. 5 shows a schematic diagram of coding binary data “101100101001011” by using the DBP mode.

Miller coding. Any edge of Miller coding in half a bit cycle represents binary “1”, while an unchanged level in a next bit cycle represents binary “0”. A level alternation occurs at the beginning of the bit cycle. For a receiver, a bit beat is easy to reconstruct. Miller coding in FIG. 5 shows a schematic diagram of coding binary data “101100101001011” by using the Miller mode.

Differential coding. In Differential coding, each binary “1” to be transmitted will cause the change of signal level, while for binary “0”, the signal level remains unchanged.

Next, the zero-power-consumption terminal is introduced in detail. Based on the power source and use mode of zero-power-consumption terminals, the zero-power-consumption terminals may be divided into the following types.

### Passive Zero-Power-Consumption Terminal

The zero-power-consumption terminal does not need a built-in battery. When the zero-power-consumption terminal is close to the network device, the zero-power-consumption terminal is within a near-field range formed by radiation of an antenna of a network device. For example, the network device is a reader/writer of a RFID system. Therefore, an antenna of the zero-power-consumption terminal generates induced current through electromagnetic induction, and the induced current drives a low-power-consumption chip circuit of the zero-power-consumption terminal. The passive zero-power-consumption terminal implements demodulation of a forward link signal and modulation of the backward link signal. For a back scattering link, the zero-power-consumption terminal uses the back scattering implementation method for signal transmission. The passive zero-power-consumption terminal is a true zero-power-consumption terminal, which does not need a built-in battery to drive either the forward link or the backward link. The passive zero-power-consumption terminal does not need a battery, and the RF circuit and baseband circuit are very simple. For example, it does not need a low noise amplifier (LNA), a PA, a crystal oscillator, an analog to digital converter (ADC) and other components, which are small in size, light in weight, very inexpensive, and has a long service life and many other advantages.

### Semi Passive Zero-Power-Consumption Terminal

The semi passive zero-power-consumption terminal itself are not installed with a conventional battery, but may use a RF power harvesting module to harvest radio wave power stored in a power storage unit. For example, the power storage unit is a capacitor. After the power storage unit obtains power, it may drive a low-power-consumption chip circuit of the zero-power-consumption terminal. The semi passive zero-power-consumption terminal implements demodulation of a forward link signal and modulation of the backward link signal. For a back scattering link, the zero-power-consumption terminal uses the back scattering implementation method for signal transmission.

The semi passive zero-power-consumption terminal does not need a built-in battery to drive either a forward link or a backward link. Power stored in a capacitor used in work comes from radio power harvested by a RF power harvesting module, which is a true zero-power-consumption terminal. The semi passive zero-power-consumption terminal includes many advantages of the passive zero-power-consumption terminal, such as small size, light weight, very cheap price, long service life and many other advantages.

### Active Zero-Power-Consumption Terminal

The active zero-power-consumption terminal may have a built-in battery. The battery is configured to drive a low-power-consumption chip circuit of the zero-power-consumption terminal. The active passive zero-power-consumption terminal implements demodulation of a forward link signal and modulation of the backward link signal. For a back scattering link, the zero-power-consumption terminal uses the back scattering implementation method for signal transmission. The zero-power consumption of the active zero-power-consumption terminal is mainly reflected in the fact that the signal transmission of the backward link does not require the terminal's own power, and uses the back scattering mode. In the active zero-power-consumption terminal, the built-in battery supplies power to a RFID chip, thereby increasing a distance of the tag for reading and writing, and improving a reliability of communication. The active zero-power-consumption terminal may be applied in some scenarios with relatively high requirements on communication distance or reading delay, etc.

With the development of the communication industry, especially the increase of 5G industry applications, there are more and more types and application scenarios of connectors. Therefore, there are higher requirements on the price and power consumption of communication terminals. The application of a passive Internet of things (IoT) device with battery-free and low cost has become the key technology of the cellular IoT, which may increase the types and number of network link terminals and truly implement the interconnection of everything. A passive IoT device may be based on the zero-power-consumption communication technology, such as RFID technology, and may be extended on this basis to be applicable to the cellular IoT.

FIG. 6 shows a schematic diagram of a zero-power-consumption communication system according to an embodiment of the present disclosure.

The zero-power-consumption communication system may include following function nodes.

A zero-power-consumption terminal 140 may harvest radio wave power by using a RF power harvesting module, and the zero-power-consumption terminal 140 uses a back scattering implementation method to transmit a signal. A network device 120 provides a communication link for the zero-power-consumption terminal, and/or provides the zero-power-consumption terminal with radio wave of the radio wave power harvested through the RF power harvesting module, i.e., power supply. A corn network (CN) 160 is configured to process and receive data, control and manage a service related to the zero-power-consumption terminal, and implements gateway and other functions. A unified data management (UDM) 180 is configured to store signing data of the zero-power-consumption terminal, and/or configuration information related to communication. The configuration information related to communication may include a bearer configuration, a zero-power-consumption terminal identifier, security configuration information, and service identifier information, etc. A cellular Internet of Things (CIoT) service 200 is configured to provide a service of the CIoT.

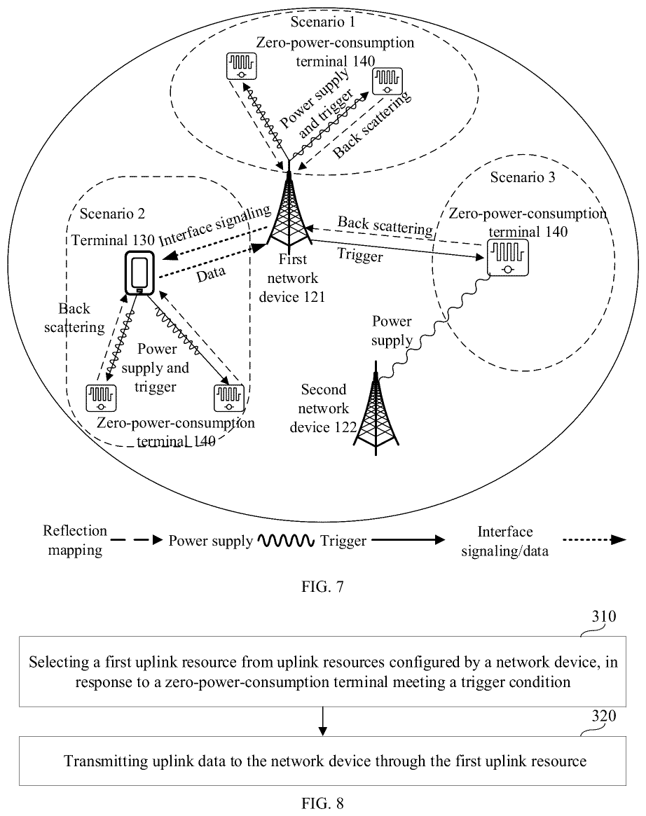

On the basis of the zero-power-consumption communication system shown in FIG. 6, the zero-power-consumption network system architecture may be a representation shown in FIG. 7. A network device supplying power to the zero-power-consumption terminal and a network device communicating with the zero-power-consumption terminal may be the same or different. There are some examples.

In scenario 1, the network device supplying power to the zero-power-consumption terminal 140 is the same as the network device communicating with the zero-power-consumption terminal 140, that is, a first network device 121 is configured to communicate with and supply power to the zero-power-consumption terminal.

In scenario 2, a terminal 130 is configured to communicate with and supply power to the zero-power-consumption terminal 140, and interface signaling and data transmission are performed between the terminal 130 and the first network device 121.

In scenario 3, the network device supplying power to the zero-power-consumption terminal 140 is different from the network device communicating with the zero-power-consumption terminal 140. A first network device 121 is configured to communicate with the zero-power-consumption terminal, and a second network device 122 is configured to supply power to the zero-power-consumption terminal, thereby improving the coverage and efficiency of power supply.

FIG. 8 is a flowchart of an uplink data transmission method of a zero-power-consumption terminal according to an embodiment of the present disclosure. The method may be performed by the zero-power-consumption terminal shown in FIG. 6. The method may include following operations.

Operation 310 may include: selecting a first uplink resource from uplink resources configured by a network device, in response to a zero-power-consumption terminal meeting a trigger condition.

In some embodiments, the trigger condition is a condition that the zero-power-consumption terminal judges whether to transmit uplink data, or the trigger condition is a condition that the zero-power-consumption terminal judges whether to respond to a downlink instruction or downlink data of the network device.

For example, the trigger condition may include but are not limited to at least one of following conditions:
a terminal attribute or a terminal configuration of the zero-power-consumption terminal matching a trigger instruction transmitted by the network device.

For example, the terminal attribute or terminal configuration may include but are not limited to at least one of a service type, group information, and a terminal identifier.

The service type is configured to mark different services. For example, the service type may be distinguished according to a packet loss rate, a time delay, and a transmission rate, etc., which is not limited. For example, the trigger instruction information instructs a zero-power-consumption terminal belonging to a first service type under a current coverage to respond. The zero-power-consumption terminal selects the first uplink resource from the uplink resources configured by the network device when the service belongs to the first service type.

The group information is configured to mark grouping information of a zero-power-consumption terminal. The same zero-power-consumption terminal belongs to at least one group. For example, a grouping basis of zero-power-consumption devices may include at least one of models, locations, and functions of the zero-power-consumption devices, which are not limited. For example, the trigger instruction information instructs the zero-power-consumption terminals belonging to a first group under current coverage to respond, and the group information of all zero-power-consumption terminals belonging to the first group is the same. The zero-power-consumption terminal selects the first uplink resource from the uplink resources configured by the network device when the group information is the same as the group information of the first group.

The terminal identifier is an identifier of a zero-power-consumption terminal, which is configured to distinguish different zero-power-consumption terminals. For example, the trigger instruction information instructs a zero-power-consumption terminal, under the current coverage, whose terminal identifier is a first value to respond. The zero-power-consumption terminal whose terminal identifier is the first value selects the first uplink resource from the uplink resources configured by the network device.

### Self-Trigger Condition

For example, the self-trigger condition includes at least one of following conditions: an access network of the zero-power-consumption terminal changing, a geographical location of the zero-power-consumption terminal changing, and a current time being a periodic trigger time.

This embodiment does not limit the selection of the trigger condition.

The zero-power-consumption terminal selects the first uplink resource from the uplink resources configured by the network device. The network device configures at least two uplink resources, and the zero-power-consumption terminal selects the first uplink resource from at least two uplink resources. This embodiment does not limit the method of the zero-power-consumption terminal selecting the first uplink resource. However, this embodiment does not exclude a case where the network device configures one uplink resource. For example, the network device configures different uplink resources for zero-power-consumption terminals having different terminal identifiers, different terminal groups, or zero-power-consumption terminals with different service types.

Operation 320 may include: transmitting uplink data to the network device through the first uplink resource.

For example, the uplink data is configured to respond to the trigger instruction and implement communication with the network device. The uplink data may include information related to the zero-power-consumption terminal, such as the terminal identifier of the zero-power-consumption terminal. In some embodiments, the uplink data may exclude information related to the zero-power-consumption terminal. This embodiment does not limit the type and content of the uplink data transmitted by the zero-power-consumption terminal to the network device.

To sum up, in the method provided in this embodiment, the zero-power-consumption terminal selects the first uplink resource from at least two uplink resources configured in the network device to transmit the uplink data, making first uplink resources selected by different zero-power-consumption terminals as different as possible, thereby reducing a possibility of uplink conflicts between multiple zero-power-consumption terminals, and improving a uplink success rate of zero-power-consumption communication.

Next, a method of the zero-power-consumption terminal receiving the uplink resource configured by network device is introduced.

For example, in case where the trigger condition includes the terminal attribute or terminal configuration of the zero-power-consumption terminal, the method of the zero-power-consumption terminal receiving the uplink resource configured by network device may include any of following three implementation methods.

It should be noted that, in some embodiment, any one of the three implementation methods may implement the zero-power-consumption terminal receiving the uplink resource configured by the network device. The three implementation methods may be implemented separately, or may be combined with other operations to form new embodiments.

Implementation method 1 may include: receiving a broadcast message periodically transmitted by the network device, the broadcast message being configured to configure the uplink resources.

For example, the broadcast message carries at least one of time domain position information and frequency domain position information of the uplink resources.

Implementation method 2 may include: receiving a trigger message transmitted by the network device, the trigger message being configured to configure the uplink resources.

For example, the trigger message carries identifier information of the uplink resources and information related to the terminal attribute.

Implementation method 3 may include: receiving a configuration message transmitted by the network device, the configuration message being configured to configure the uplink resources, a time domain position corresponding to the configuration message is later than a time domain position corresponding to the trigger message.

For example, the trigger message carries identifier information of the uplink resources and information related to the terminal configuration.

For example, in case where the trigger condition includes the self-trigger condition, the zero-power-consumption terminal receiving the uplink resource configured by network device may include one of following implementation methods.

Implementation method 1 may include: receiving a broadcast message periodically transmitted by the network device, the broadcast message being configured to configure the uplink resources.

For example, the broadcast message carries at least one of time domain position information and frequency domain position information of the uplink resources.

Next, a method of the zero-power-consumption terminal selecting the first uplink resource from the uplink resources configured by the network device is introduced. For example, the method of the zero-power-consumption terminal selecting the first uplink resource from the uplink resources configured by the network device may include any of following three implementation methods.

It should be noted that, in some embodiment, any one of the three implementation methods may implement the zero-power-consumption terminal selecting the first uplink resource. The three implementation methods may be implemented separately, or may be combined with other operations to form new embodiments.

Implementation method 1 may include: selecting the first uplink resource based on a terminal identifier of the zero-power-consumption terminal and the number of the uplink resources, in response to the zero-power-consumption terminal meeting the trigger condition.

For example, a resource serial number of the first uplink resource selected by the zero-power-consumption terminal is equal to a remainder obtained by the terminal identifier divided by the number of the uplink resources.

Resource_valid_ID=UE_ID mod K

Resource_valid_ID represents a resource serial number of the first uplink resource selected by the zero-power-consumption terminal, UE_ID represents the terminal identifier, K represents the number of uplink resources, and mod represents the operation of obtaining the remainder. For example, the serial number of K uplink resources configured by the network device is: 0, 1, . . . , K−1. For example, the terminal identifier is 23, the number of uplink resources is 5, and the resource serial number of the first uplink resource selected by the zero-power-consumption terminal is 3. This embodiment does not limit the relationship between the first uplink resource selected by the zero-power-consumption terminal and the terminal identifier and the number of uplink resources.

Implementation method 2 may include: selecting the first uplink resource from the uplink resources configured by the network device based on a first timer, in response to the zero-power-consumption terminal meeting the trigger condition.

For example, the selecting a first uplink resource from the uplink resources configured by the network device based on a first timer may include following operations.

The above operations may include: starting the first timer, in response to the trigger condition being met. For example, the first timer is an access timer maintained by the zero-power-consumption terminal, and a duration of the first timer is pre-configured by the zero-power-consumption terminal.

The above operations may include: in response to timeout of the first timer, selecting an uplink resource, closest to the timeout time in a time domain, from the uplink resources configured by the network device, and determining the uplink resource closest to the timeout time as the first uplink resource. For example, the timeout time of the first timer is a first time, the network device configures uplink resource 1 and uplink resource 2. Compared with uplink resource 1, a time domain position of uplink resource 2 is closer to the first time. The zero-power-consumption terminal determines the uplink resource 2 as the first uplink resource, and the time domain position of the first uplink resource is later than the timeout time of the first timer. This embodiment does not limit the relationship between the time domain information of the first uplink resource and the first timer.

Implementation method 3 may include: randomly selecting the first uplink resource from the uplink resources configured by the network device, in response to the zero-power-consumption terminal meeting the trigger condition.

The zero-power-consumption terminal randomly selects the first uplink resource from multiple uplink resources.

To sum up, the method provided in some embodiments increases bases of the zero-power-consumption terminal selecting the first uplink resource for transmitting uplink data from at least two uplink resources configured by the network device. The selection of the first uplink resource is associated with the terminal identifier, the timer, and the random number, so that the first uplink resources selected by different zero-power-consumption terminals are as different as possible, thereby reducing the possibility of uplink conflicts between multiple zero-power-consumption terminals, and improving the uplink success rate of zero-power-consumption communication.

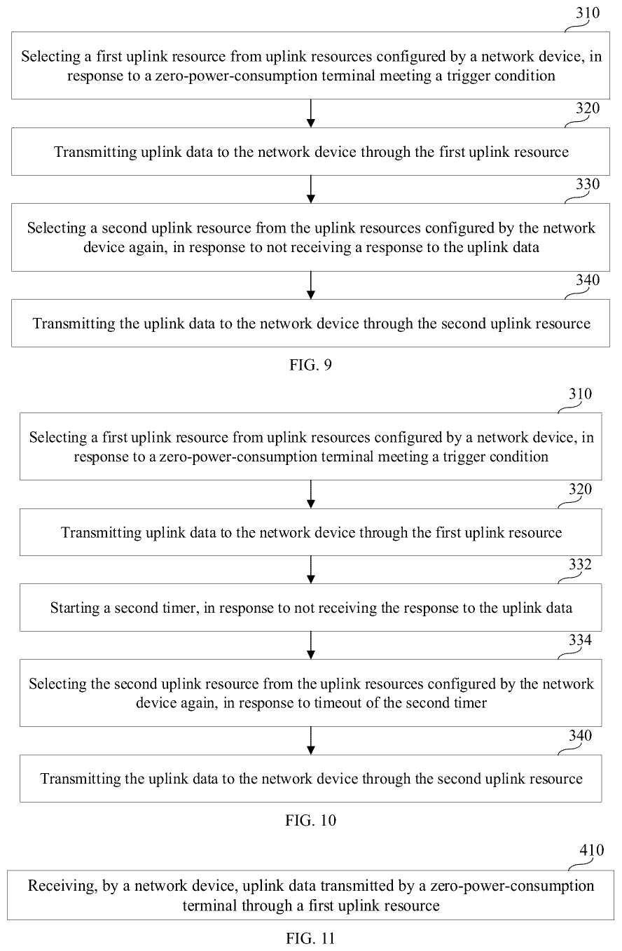

FIG. 9 is a flowchart of an uplink data transmission method of a zero-power-consumption terminal according to an embodiment of the present disclosure. The method may be performed by the zero-power-consumption terminal shown in FIG. 6. The method may include following operations.

Operation 310 may include: selecting a first uplink resource from uplink resources configured by a network device, in response to a zero-power-consumption terminal meeting a trigger condition.

Operation 320 may include: transmitting uplink data to the network device through the first uplink resource.

Operations 310 and 320 may refer to the operations in the above embodiments shown in FIG. 8, and are not repeated in this embodiment.

Operation 330 may include: selecting a second uplink resource from the uplink resources configured by the network device again, in response to not receiving a response to the uplink data.

After the zero-power-consumption terminal transmits the uplink data to the network device through the first uplink resource, it receives downlink data through a corresponding downlink resource. In response to not receiving the response to the uplink data, that is, the first uplink resource does not complete communication with the network device, the zero-power-consumption terminal selects the second uplink resource from the uplink resources configured by the network device again. For example, a conflict is occurred on the first uplink resource. The zero-power-consumption terminal selects the second uplink resource from the uplink resources configured by the network device again.

The not receiving the response to the uplink data may include following cases.

In some cases, the zero-power-consumption terminal does not receive a downlink feedback transmitted by the network device. In some cases, the zero-power-consumption terminal receives the downlink feedback transmitted by the network device, the downlink feedback does not include receiving information, and the receiving information is configured to indicate that the network device has successfully received the uplink data transmitted by the zero-power-consumption terminal.

Operation 340 may include: transmitting the uplink data to the network device through the second uplink resource.

This embodiment does not limit types of the uplink data transmitted by the zero-power-consumption terminal to the network device.

To sum up, in the method provided in this embodiment, in response to not receiving the response to the uplink data, the zero-power-consumption terminal may select the second uplink resource from at least two uplink resources configured by the network device to transmit the uplink data, and may select the uplink resource again, thereby solving the problem of uplink conflict between multiple zero-power-consumption terminals, and improving the uplink success rate of zero-power-consumption communication.

FIG. 10 is a flowchart of an uplink data transmission method of a zero-power-consumption terminal according to an embodiment of the present disclosure. The method may be performed by the zero-power-consumption terminal shown in FIG. 6. The method may include following operations.

Operation 310 may include: selecting a first uplink resource from uplink resources configured by a network device, in response to a zero-power-consumption terminal meeting a trigger condition.

Operation 320 may include: transmitting uplink data to the network device through the first uplink resource.

Operations 310 and 320 may refer to the operations in the above embodiments shown in FIG. 8, and are not repeated in this embodiment.

Operation 332 may include: starting a second timer, in response to not receiving the response to the uplink data.

For example, the second timer is a timer maintained by the zero-power-consumption terminal. This embodiment does not limit a selection of a timer duration of the second timer. In some embodiments, the second timer and the first timer are the same timer, and the second timer is only started in response to not receiving the response to the uplink data.

For example, the starting a second timer, in response to not receiving the response to the uplink data may include any of following two implementation methods.

Implementation method 1 may include: starting the second timer, in response to not receiving the response to the uplink data and receiving instruction information of the network device.

For example, in case where the zero-power-consumption terminal receives the instruction information of the network device. The timer duration of the second timer may be selected based on the instruction information of the network device, and the zero-power-consumption terminal starts the second timer. The timer duration of the second timer may be determined as a default duration, and the zero-power-consumption terminal starts the second timer. The default duration may be preset by the zero-power-consumption device, or may be preset by the network device and transmitted to the zero-power-consumption terminal in advance, or may be determined by the zero-power-consumption terminal and the network device through negotiation in advance. This embodiment does not limit the determination method of the default duration.

Implementation method 2 may include: starting the second timer, in response to not receiving the response to the uplink data and the instruction information of the network device.

For example, in response to not receiving the instruction information of the network device, the timer duration of the second timer is determined as the default duration, and the zero-power-consumption terminal starts the second timer.

It should be noted that, in some embodiments, any of the two implementation methods may start the second timer, and the two implementation methods may be implemented separately, or may be combined with other operations to form a new embodiment.

For example, in following two implementation methods, the instruction information of the network device may include at least one of following information:
a starting instruction of the second timer; and a timer duration of the second timer.

Operation 334 may include: selecting the second uplink resource from the uplink resources configured by the network device again, in response to timeout of the second timer.

The zero-power-consumption terminal selects the second uplink resource from the uplink resources configured by the network device again at a timeout time of second timer or at any time after the timeout time of second timer. The uplink resource configured by the network for the zero-power-consumption terminal to select the second uplink resource and uplink resource configured by the network for the zero-power-consumption terminal to select the first uplink resource may be the same or different.

Operation 340 may include: transmitting the uplink data to the network device through the second uplink resource.

Operation 340 may refer to the operation in the above embodiments shown in FIG. 9, and is not repeated in this embodiment.

To sum up, in the method provided in this embodiment, in response to not receiving the response to the uplink data, the zero-power-consumption terminal selects the second uplink resource from at least two uplink resources configured by the network device to transmit uplink data, adds the second timer, and associates the second timer with the re-selection of the uplink resource, so that the uplink resource may be selected again, thereby solving the problem of uplink conflict between multiple zero-power-consumption terminals, and improving the uplink success rate of zero-power-consumption communication.

Next, a basis of determining the timer duration of the second timer is introduced. For example, determining the timer duration of the second timer may include any of following five implementation methods.

It should be noted that, in some embodiments, any one of the five implementation methods may implement the zero-power-consumption terminal selecting the second uplink resource. The five implementation methods may be implemented separately, or may be combined with other operations to form a new embodiment.

Implementation method 1 may include: determining the timer duration of the second timer based on a priority of the zero-power-consumption terminal.

This embodiment does not limit a basis of determining the priority of the zero-power-consumption terminal. For example, the basis of determining the priority of zero-power-consumption terminal includes but is not limited to at least one of a zero-power-consumption terminal, a zero-power-consumption terminal group, a service, and a service type.

In some embodiments, implementation method 1 may include: receiving configuration information. The configuration information is configured to configure the priority. For example, the basis of configuring the priority includes but is not limited to at least one of a zero-power-consumption terminal, a zero-power-consumption terminal group, a service, and a service type, which is not limited. For example, the priority corresponds to the zero-power-consumption terminal, or corresponds to the group of the zero-power-consumption terminal, or corresponds to the service of the zero-power-consumption terminal, or corresponds to the service type group of the zero-power-consumption terminal.

In some embodiments, implementation method 1 may include: obtaining pre-configuration information; the pre-configuration information being pre-configured by the zero-power-consumption terminal, and the pre-configuration information being configured to configure the priority. For example, the basis of configuring the priority includes but is not limited to at least one of a zero-power-consumption terminal, a zero-power-consumption terminal group, a service, and a service type, which is not limited. For example, the priority corresponds to the zero-power-consumption terminal, or corresponds to the group of the zero-power-consumption terminal, or corresponds to the service of the zero-power-consumption terminal, or corresponds to the service type group of the zero-power-consumption terminal.

Implementation method 2 may include: randomly selecting the timer duration of the second timer from multiple candidate timer durations.

The candidate timer duration may be set by the zero-power-consumption terminal or the network device, which is not limited. For example, the candidate timer duration may include 1 s, 3 s, and 6 s, and 3 s is selected as the timer duration of the second timer.

Implementation method 3 may include: selecting the timer duration of the second timer from the multiple candidate timer durations based on the instruction information of the network device.

The instruction information of the network device carries information instructing the zero-power-consumption terminal to start the second timer and information selecting the timer duration of the second timer. This embodiment does not limit the basis of the network device instructing the zero-power-consumption terminal to start the second timer, and this embodiment does not limit the method of the instruction information instructing the timer duration of the second timer. For example, the candidate timer duration may include Is, 3s, and 6s. The instruction information instructs that the timer duration of the second timer is 3 s, or the instruction information instructs that the timer duration of the second timer is a candidate timer duration with the longest duration.

Implementation method 4 may include: selecting the timer duration of the second timer from multiple candidate timer durations based on a terminal identifier of the zero-power-consumption terminal and the number of the multiple candidate timer durations.

For example, the timer duration of the second timer is a first candidate timer duration, and the serial number corresponding to the first candidate timer duration is equal to the remainder obtained by the terminal identifier of the zero-power-consumption terminal divided by the number of candidate timer durations.

Candidate_timer_ID=UE_ID mod M

Candidate_timer_ID represents a serial number corresponding to the first candidate timer duration, UE_ID represents the terminal identifier, M represents the number of candidate timer durations, and mod represents the operation of obtaining the remainder. For example, the serial number of the m candidate timer durations configured by the network device is: 0, 1, . . . , M−1. For example, the terminal identifier is 23, the number of candidate timer durations is 5, the serial number corresponding to the first candidate timer duration is equal to 3, and the timer duration of the second timer is the first candidate timer duration. This embodiment does not limit the relationship between the timer duration of the second timer selected by the zero-power-consumption terminal and the terminal identifier and the number of the candidate timer durations.

Implementation method 5 may include: determining the timer duration of the second timer as a default duration.

The default duration may be preset by the zero-power-consumption device, or may be preset by the network device and transmitted to the zero-power-consumption terminal in advance, or may be determined by the zero-power-consumption terminal and the network device through negotiation in advance. This embodiment does not limit the determination method of the default duration.

To sum up, the method provided in this embodiment increases the timer duration setting method of the second timer, increases the opportunity for the zero-power-consumption terminal to select uplink resources, and makes first uplink resources selected by different zero-power-consumption terminals as different as possible. In response to not receiving the response to the uplink data, the zero-power-consumption terminal may select an uplink resource again, thereby solving the problem of uplink conflict between multiple zero-power-consumption terminals, and improving the uplink success rate of zero-power-consumption communication.

Next, a method of the zero-power-consumption terminal selecting the second uplink resource from the uplink resources configured by the network device is introduced. For example, the method of the zero-power-consumption terminal selecting the second uplink resource from the uplink resources configured by the network device may include any of following three implementation methods.

It should be noted that, in some embodiment, any one of the three implementation methods may implement the zero-power-consumption terminal selecting the second uplink resource. The three implementation methods may be implemented separately, or may be combined with other operations to form a new embodiment.

Implementation method 1 may include: selecting the second uplink resource based on the terminal identifier of the zero-power-consumption terminal and the number of the uplink resources, in response to not receiving the response to the uplink data.

For example, a resource serial number of the second uplink resource selected by the zero-power-consumption terminal is equal to a remainder obtained by the terminal identifier divided by the number of the uplink resources.

Resource_valid_ID=UE_ID mod K

Resource_valid_ID represents a resource serial number of the second uplink resource selected by the zero-power-consumption terminal, UE_ID represents the terminal identifier, K represents the number of uplink resources, and mod represents the operation of obtaining the remainder. For example, the serial number of K uplink resources configured by the network device is: 0, 1, . . . , K−1. For example, the terminal identifier is 23, the number of uplink resources is 5, and the resource serial number of the second uplink resource selected by the zero-power-consumption terminal is 3. This embodiment does not limit the relationship between the second uplink resource selected by the zero-power-consumption terminal and the terminal identifier and the number of uplink resources.

Implementation method 2 may include: selecting the second uplink resource from the uplink resources configured by the network device based on the second timer, in response to not receiving the response to the uplink data.

For example, in response to timeout of the second timer, an uplink resource, closest to the timeout time in a time domain, of the uplink resources configured by the network device is select and determined as the second uplink resource. For example, the timeout time of the second timer is a first time, the network device configures uplink resource 1 and uplink resource 2. Compared with uplink resource 1, a time domain position of uplink resource 2 is closer to the first time. The zero-power-consumption terminal determines the uplink resource 2 as the second uplink resource, and the time domain position of the second uplink resource is later than the timeout time of the second timer. This embodiment does not limit the relationship between the time domain information of the second uplink resource and the second timer.

Implementation method 3 may include: in response to not receiving the response to the uplink data, randomly selecting the second uplink resource from the uplink resources configured by the network device.

The zero-power-consumption terminal randomly selects the second uplink resource from multiple uplink resources.

To sum up, in the method provided in this embodiment, in response to not receiving the response to the uplink data, the zero-power-consumption terminal may select the second uplink resource from at least two uplink resources configured by the network device to transmit the uplink data, and may select the uplink resource again, thereby solving the problem of uplink conflict between multiple zero-power-consumption terminals, and improving the uplink success rate of zero-power-consumption communication.

FIG. 11 is a flowchart of an uplink data receiving method of a network device according to an embodiment of the present disclosure. The method may be performed by the network device shown in FIG. 6. The method may include following operations.

Operation 410 may include: receiving, by a network device, uplink data transmitted by a zero-power-consumption terminal through a first uplink resource.

The first uplink resource is selected from the uplink resources configured by the network device, in response to the zero-power-consumption terminal meeting a trigger condition.

For example, after the network device configures the uplink resources, the network device monitors each configured uplink resource, and waits to receive the uplink data transmitted by the zero-power-consumption terminal.

The trigger condition is a judgment condition for the zero-power-consumption terminal to judge whether to select the uplink resource. The zero-power-consumption terminal selects the first uplink resource from the uplink resources configured by the network device, in response to the trigger condition being met. For example, the trigger condition may include but are not limited to at least one of following conditions:
a terminal attribute or a terminal configuration of the zero-power-consumption terminal matching a trigger instruction transmitted by the network device.

For example, the terminal attribute or terminal configuration may include but are not limited to at least one of a service type, group information, and a terminal identifier.

The service type is configured to mark different services. For example, the service type may be distinguished according to a packet loss rate, a time delay, and a transmission rate, etc., which is not limited. For example, the trigger instruction information instructs a zero-power-consumption terminal belonging to a first service type under a current coverage to respond. The zero-power-consumption terminal selects the first uplink resource from the uplink resources configured by the network device when the service belongs to the first service type.

The group information is configured to mark grouping information of a zero-power-consumption terminal. The same zero-power-consumption terminal belongs to at least one group. For example, a grouping basis of zero-power-consumption devices may include at least one of models, locations, and functions of the zero-power-consumption devices, which are not limited. For example, the trigger instruction information instructs the zero-power-consumption terminals belonging to a first group under current coverage to respond, and the group information of all zero-power-consumption terminals belonging to the first group is the same. The zero-power-consumption terminal selects the first uplink resource from the uplink resources configured by the network device when the group information is the same as the group information of the first group.

The terminal identifier is an identifier of a zero-power-consumption terminal, which is configured to distinguish different zero-power-consumption terminals. For example, the trigger instruction information instructs a zero-power-consumption terminal, under the current coverage, whose terminal identifier is a first value to respond. The zero-power-consumption terminal whose terminal identifier is the first value selects the first uplink resource from the uplink resources configured by the network device.

Self-trigger conditions. For example, the self-trigger condition includes at least one of following conditions: an access network of the zero-power-consumption terminal changing, a geographical location of the zero-power-consumption terminal changing, and a current time being a periodic trigger time.

This embodiment does not limit the selection of the trigger condition.

The zero-power-consumption terminal selects the first uplink resource from the uplink resources configured by the network device. The network device configures at least two uplink resources, and the zero-power-consumption terminal selects the first uplink resource from at least two uplink resources. This embodiment does not limit the method of the zero-power-consumption terminal selecting the first uplink resource. However, this embodiment does not exclude a case where the network device configures one uplink resource. For example, the network device configures different uplink resources for zero-power-consumption terminals having different terminal identifiers, different terminal groups, or zero-power-consumption terminals with different service types.

To sum up, in the method provided by this embodiment, the network device receives the uplink data transmitted by the zero-power-consumption terminal through the first uplink resource, thereby reducing the possibility of uplink conflicts between multiple zero-power-consumption terminals, and laying a foundation for improving the uplink success rate of zero-power-consumption communication.

Next, a method of the network device transmitting the configured uplink resource to the zero-power-consumption terminal is introduced.

For example, in case where the trigger condition includes the terminal attribute or terminal configuration of the zero-power-consumption terminal, the network device transmitting the configured uplink resource to the zero-power-consumption terminal may include any of the following implementation methods.

It should be noted that, in some embodiments, any one of the three implementation methods may implement the network device transmitting the configured uplink resource to the zero-power-consumption terminal. The three implementation methods may be implemented separately, or may be combined with other operations to form a new embodiment.

Implementation method 1 may include: periodically transmitting, by the network device, a broadcast message to the zero-power-consumption terminal, the broadcast message being configured to configure the uplink resources.

For example, the broadcast message carries at least one of time domain position information and frequency domain position information of the uplink resources.

Implementation method 2 may include: transmitting, by the network device, a trigger message to the zero-power-consumption terminal, the trigger message being configured to configure the uplink resources.

For example, the trigger message carries identifier information of the uplink resources and information related to the terminal attribute.

Implementation method 3 may include: transmitting, by the network device, a configuration message to the zero-power-consumption terminal, the configuration message being configured to configure the uplink resources, a time domain position corresponding to the configuration message is later than a time domain position corresponding to the trigger message.

For example, the trigger message carries identifier information of the uplink resources and information related to the terminal configuration.

For example, in case where the trigger condition includes the self-trigger condition, the network device transmitting the configured uplink resource to the zero-power-consumption terminal may include one of the implementation methods.

Implementation method 1 may include: periodically transmitting, by the network device, the broadcast message to the zero-power-consumption terminal, the broadcast message being configured to configure the uplink resources.

For example, the broadcast message carries at least one of the time domain position information and the frequency domain position information of the uplink resources.

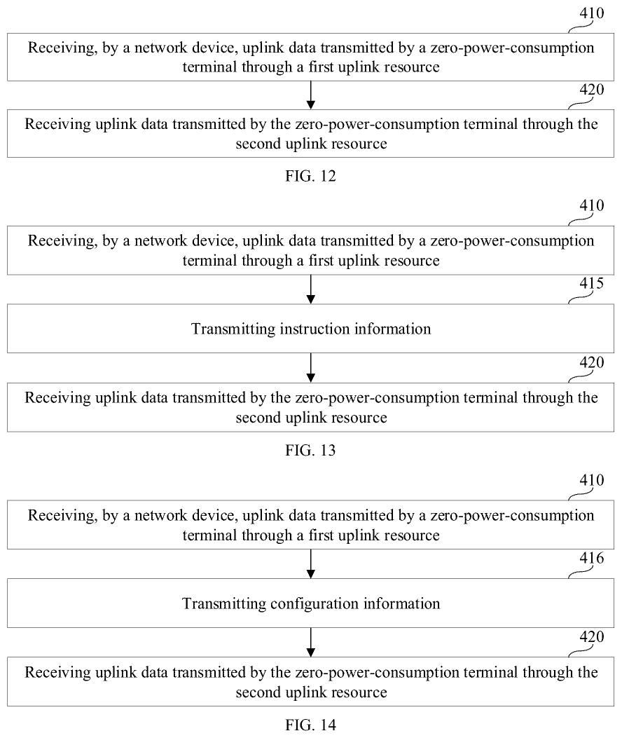

FIG. 12 is a flowchart an uplink data receiving method of a network device according to an embodiment of the present disclosure. The method may be performed by the network device shown in FIG. 6. The method may include following operations.

Operation 410 may include: receiving, by a network device, uplink data transmitted by a zero-power-consumption terminal through a first uplink resource.

Operation 410 may refer to the operations in the above embodiments shown in FIG. 11, and is not repeated in this embodiment.

Operation 420 may include: receiving uplink data transmitted by the zero-power-consumption terminal through the second uplink resource.

The second uplink resource is selected from the uplink resources configured by the network device, in response to the zero-power-consumption terminal not receiving a response to the uplink data.

The zero-power-consumption terminal starts a second timer in response to not receiving the response to the uplink data. The second uplink resource is selected again from the uplink resources configured by the network device in response to timeout of the second timer.

For example, determining the timer duration of the second timer may include any of following five implementation methods.

It should be noted that, in some embodiments, any one of the five implementation methods may implement the zero-power-consumption terminal selecting the second uplink resource. The five implementation methods may be implemented separately, or may be combined with other operations to form a new embodiment.

Implementation method 1 may include: determining the timer duration of the second timer based on a priority of the zero-power-consumption terminal.

This embodiment does not limit a basis of determining the priority of the zero-power-consumption terminal. For example, the basis of determining the priority of zero-power-consumption terminal includes but is not limited to at least one of a zero-power-consumption terminal, a zero-power-consumption terminal group, a service, and a service type.

In some embodiments, implementation method 1 may include: receiving configuration information. The configuration information is configured to configure the priority. For example, the basis of configuring the priority includes but is not limited to at least one of a zero-power-consumption terminal, a zero-power-consumption terminal group, a service, and a service type, which is not limited. For example, the priority corresponds to the zero-power-consumption terminal, or corresponds to the group of the zero-power-consumption terminal, or corresponds to the service of the zero-power-consumption terminal, or corresponds to the service type group of the zero-power-consumption terminal.

In some embodiments, implementation method 1 may include: obtaining pre-configuration information; the pre-configuration information being pre-configured by the zero-power-consumption terminal, and the pre-configuration information being configured to the priority. For example, the basis of configuring the priority includes but is not limited to at least one of a zero-power-consumption terminal, a zero-power-consumption terminal group, a service, and a service type, which is not limited.

Implementation method 2 may include: randomly selecting the timer duration of the second timer from multiple candidate timer durations.

The candidate timer duration may be set by the zero-power-consumption terminal or the network device, which is not limited. For example, the candidate timer duration may include 1 s, 3 s, and 6 s, and 3 s is selected as the timer duration of the second timer.

Implementation method 3 may include: selecting the timer duration of the second timer from the multiple candidate timer durations based on the instruction information of the network device.

The instruction information of the network device carries information instructing the zero-power-consumption terminal to start the second timer and information selecting the timer duration of the second timer. This embodiment does not limit the basis of the network device instructing the zero-power-consumption terminal to start the second timer, and this embodiment does not limit the method of the instruction information instructing the timer duration of the second timer. For example, the candidate timer duration may include 1 s, 3 s, and 6 s. The instruction information instructs that the timer duration of the second timer is 3 s, or the instruction information instructs that the timer duration of the second timer is a candidate timer duration with the longest duration.

Implementation method 4 may include: selecting the timer duration of the second timer from multiple candidate timer durations based on a terminal identifier of the zero-power-consumption terminal and the number of the multiple candidate timer durations.

For example, the timer duration of the second timer is a first candidate timer duration, and the serial number corresponding to the first candidate timer duration is equal to the remainder obtained by the terminal identifier of the zero-power-consumption terminal divided by the number of candidate timer durations.

Candidate_timer_ID=UE_ID mod M

Candidate_timer_ID represents a serial number corresponding to the first candidate timer duration, UE_ID represents the terminal identifier, M represents the number of candidate timer durations, and mod represents the operation of obtaining the remainder. For example, the serial number of the m candidate timer durations configured by the network device is: 0, 1, . . . , M−1. For example, the terminal identifier is 23, the number of candidate timer durations is 5, the serial number corresponding to the first candidate timer duration is equal to 3, and the timer duration of the second timer is the first candidate timer duration. This embodiment does not limit the relationship between the timer duration of the second timer selected by the zero-power-consumption terminal and the terminal identifier and the number of the candidate timer durations.

Implementation method 5 may include: determining the timer duration of the second timer as a default duration.

The default duration may be preset by the zero-power-consumption device, or may be preset by the network device and transmitted to the zero-power-consumption terminal in advance, or may be determined by the zero-power-consumption terminal and the network device through negotiation in advance. This embodiment does not limit the determination method of the default duration.

To sum up, in the method provided by this embodiment, the network device receives the uplink data transmitted by the zero-power-consumption terminal through the first uplink resource, and receives the uplink data transmitted by the zero-power-consumption terminal through the second uplink resource, thereby reducing the possibility of uplink conflicts between multiple zero-power-consumption terminals, and laying a foundation for improving the uplink success rate of zero-power-consumption communication.

FIG. 13 is a flowchart of an uplink data receiving method of a network device according to an embodiment of the present disclosure. The method may be performed by the network device shown in FIG. 6. The method may include following operations.

Operation 410 may include: receiving, by a network device, uplink data transmitted by a zero-power-consumption terminal through a first uplink resource.

Operation 410 may refer to the operations in the above embodiments shown in FIG. 11, and is not repeated in this embodiment.

Operation 415 may include: transmitting instruction information.

The instruction information is configured to instruct information related to the second timer. The instruction information may include at least one of following information:
a starting instruction of the second timer; and
a timer duration of the second timer.

For example, in case where the zero-power-consumption terminal receives the instruction information of the network device, the timer duration of the second timer may be selected based on the instruction information of the network device, and the zero-power-consumption terminal starts the second timer.

Operation 420 may include: receiving uplink data transmitted by the zero-power-consumption terminal through the second uplink resource.

Operation 420 may refer to the operations in the above embodiments shown in FIG. 12, and is not repeated in this embodiment.

To sum up, in the method provided in this embodiment, the network device transmits the instruction information to the zero-power-consumption terminal, which increases a way of obtaining information related to the second timer, thereby reducing the possibility of uplink conflicts between multiple zero-power-consumption terminals, and laying a foundation for improving the uplink success rate of zero-power-consumption communication.

FIG. 14 is a flowchart of an uplink data receiving method of a network device according to an embodiment of the present disclosure. The method may be performed by the network device shown in FIG. 6. The method may include following operations.

Operation 410 may include: receiving, by a network device, uplink data transmitted by a zero-power-consumption terminal through a first uplink resource.

Operation 410 may refer to the operations in the above embodiments shown in FIG. 11, and is not repeated in this embodiment.

Operation 416 may include: transmitting configuration information.

The configuration information is configured to configure a priority. For example, the basis of configuring the priority includes but is not limited to at least one of a zero-power-consumption terminal, a zero-power-consumption terminal group, a service, and a service type, which is not limited.

Operation 420 may include: receiving uplink data transmitted by the zero-power-consumption terminal through the second uplink resource.

Operation 420 may refer to the operations in the above embodiments shown in FIG. 12, and is not repeated in this embodiment.

To sum up, in the method provided in this embodiment, the network device transmits the configuration information to the zero-power-consumption terminal, which increases the method of selecting the timer duration of the second timer, thereby reducing the possibility of uplink conflicts between multiple zero-power-consumption terminals, and laying a foundation for improving the uplink success rate of zero-power-consumption communication.

Those skilled in the art may understand that the above embodiments may be implemented independently, or they may be combined freely to form new embodiments, which are not limited.

The following are apparatus embodiments of the present disclosure, which may be configured to perform the method embodiments of the present disclosure. Details not disclosed in the apparatus embodiments of the present disclosure may refer to the method embodiments of the present disclosure.

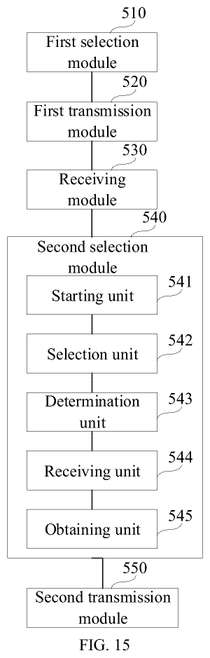

FIG. 15 is a block diagram of an uplink data transmission apparatus of a zero-power-consumption terminal according to an embodiment of the present disclosure. The apparatus may include a first selection module 510, configured to select a first uplink resource from uplink resources configured by a network device, in response to a zero-power-consumption terminal meeting a trigger condition; a first transmission module 520, configured to transmit uplink data to the network device through the first uplink resource.

In some embodiments, the trigger condition may include a terminal attribute or a terminal configuration of the zero-power-consumption terminal matching a trigger instruction transmitted by the network device.

In some embodiments, the terminal attribute or terminal configuration may include at least one of a service type, group information, and a terminal identifier.

In some embodiments, the trigger condition includes a self-trigger condition.

In some embodiments, the self-trigger condition includes an access network of the zero-power-consumption terminal changing, a geographical location of the zero-power-consumption terminal changing, and a current time being a periodic trigger time.

In some embodiments, the apparatus includes a receiving module 530, configured to receive a broadcast message periodically transmitted by the network device; the broadcast message is configured to configure the uplink resources; or receive a trigger message transmitted by the network device; the trigger message is configured to configure the uplink resources; or receive a configuration message transmitted by the network device; the configuration message is configured to configure the uplink resources, a time domain position corresponding to the configuration message is later than a time domain position corresponding to the trigger message.

In some embodiments, the receiving module 530 is configured to receive a broadcast message periodically transmitted by the network device; the broadcast message is configured to configure the uplink resources.

In some embodiments, the first selection module 510 is configured to select the first uplink resource based on a terminal identifier of the zero-power-consumption terminal and the number of the uplink resources; or select the first uplink resource from the uplink resources configured by the network device based on a first timer; or randomly select the first uplink resource from the uplink resources configured by the network device.

In some embodiments, a resource serial number of the first uplink resource is equal to a remainder obtained by the terminal identifier divided by the number of the uplink resources.

In some embodiments, the first selection module 510 is configured to start the first timer, in response to the trigger condition being met; and in response to timeout of the first timer, select an uplink resource, closest to the timeout time in a time domain, from the uplink resources configured by the network device, and determine the uplink resource closest to the timeout time as the first uplink resource

In some embodiments, the apparatus includes a second selection module 540, configured to select a second uplink resource from the uplink resources configured by the network device again, in response to not receiving a response to the uplink data; and a second transmission module 550, configured to transmit the uplink data to the network device through the second uplink resource.

In some embodiments, the second transmission module 550 includes a starting unit 541, configured to start a second timer, in response to not receiving the response to the uplink data; a selection unit 542, configured to select the second uplink resource from the uplink resources configured by the network device again, in response to timeout of the second timer.

In some embodiments, a case of not receiving the response to the uplink data include: the zero-power-consumption terminal not receiving a downlink feedback transmitted by the network device; or the zero-power-consumption terminal receiving the downlink feedback transmitted by the network device, and the downlink feedback not including receiving information, the receiving information is configured to indicate that the network device has successfully received the uplink data transmitted by the zero-power-consumption terminal.

In some embodiments, the starting unit 541 is configured to start the second timer, in response to not receiving the response to the uplink data and receiving instruction information of the network device; or start the second timer, in response to not receiving the response to the uplink data and the instruction information of the network device.

In some embodiments, the instruction information of the network device includes at least one of: a starting instruction of the second timer; and a timer duration of the second timer.

In some embodiments, the apparatus includes a determination unit 543, configured to determine the timer duration of the second timer based on a priority of the zero-power-consumption terminal; or randomly select the timer duration of the second timer from multiple candidate timer durations; or select the timer duration of the second timer from the multiple candidate timer durations based on the instruction information of the network device; or select the timer duration of the second timer from the multiple candidate timer durations based on a terminal identifier of the zero-power-consumption terminal and the number of the multiple candidate timer durations; or determine the timer duration of the second timer as a default duration.

In some embodiments, the timer duration of the second timer is equal to a remainder obtained by the terminal identifier of the zero-power-consumption terminal divided by the number of the multiple candidate timer durations.

In some embodiments, the apparatus includes a receiving unit 544, configured to: receive configuration information; the configuration information is configured to configure the priority; and a obtaining unit 545, configured to: obtain pre-configuration information; the pre-configuration information includes the priority; the priority corresponds to the zero-power-consumption terminal, or corresponds to a terminal group of the zero-power-consumption terminal, or corresponds to a service of the zero-power-consumption terminal, or corresponds to a service type group of the zero-power-consumption terminal.

In some embodiments, the second selection module 540 is configured to select the second uplink resource based on a terminal identifier of the zero-power-consumption terminal and the number of the uplink resources; or select the second uplink resource from the uplink resources configured by the network device based on a second timer; or randomly select the second uplink resource from the uplink resources configured by the network device.

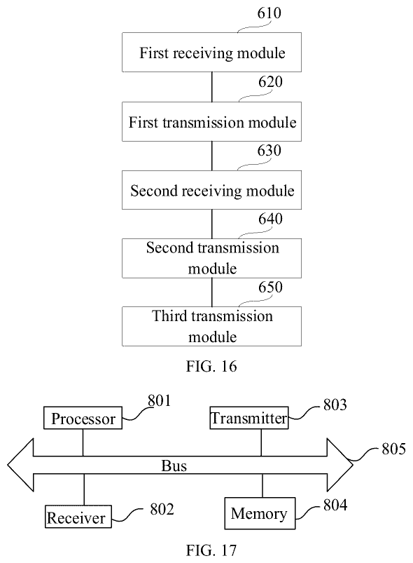

FIG. 16 is a block diagram of an uplink data receiving apparatus of a network device according to an embodiment of the present disclosure. The apparatus includes a first receiving module 610, configured to receive uplink data transmitted by the zero-power-consumption terminal through a first uplink resource; the first uplink resource is selected from the uplink resources configured by the network device, in response to the zero-power-consumption terminal meeting a trigger condition.

In some embodiments, the trigger condition includes a terminal attribute or a terminal configuration of the zero-power-consumption terminal matching a trigger instruction transmitted by the network device.

In some embodiments, the terminal attribute or the terminal configuration includes at least one of: a service type; group information; and a terminal identifier.

In some embodiments, the trigger condition includes a self-trigger condition.

In some embodiments, the self-trigger condition includes: an access network of the zero-power-consumption terminal changing; a geographical location of the zero-power-consumption terminal changing; and a current time being a periodic trigger time.

In some embodiments, the apparatus includes a first transmission module 620, configured to periodically transmit a broadcast message to the zero-power-consumption terminal; the broadcast message is configured to configure the uplink resources; or transmit a trigger message to the zero-power-consumption terminal; the trigger message is configured to configure the uplink resources; or transmit a configuration message to the zero-power-consumption terminal; the configuration message is configured to configure the uplink resources, a time domain position corresponding to the configuration message is later than a time domain position corresponding to the trigger message.

In some embodiments, the first transmission module 620 is configured to periodically transmit a broadcast message to the zero-power-consumption terminal; the broadcast message is configured to configure the uplink resources.

In some embodiments, the apparatus includes a second receiving module 630, configured to receive the uplink data transmitted by the zero-power-consumption terminal through a second uplink resource; the second uplink resource is selected from the uplink resources configured by the network device, in response to the zero-power-consumption terminal not receiving a response to the uplink data.

In some embodiments, the zero-power-consumption terminal starts a second timer in response to not receiving the response to the uplink data; and the zero-power-consumption terminal selects the second uplink resource again from the uplink resource configured by the network device in response to timeout of the second timer.

In some embodiments, timer duration of the second timer is determined based on a priority of the zero-power-consumption terminal; or the timer duration of the second timer is randomly selected by the zero-power-consumption terminal from multiple candidate timer durations; or the timer duration of the second timer is selected from the multiple candidate timer durations based on instruction information of the network device; or the timer duration of the second timer is selected by the zero-power-consumption terminal from the multiple candidate timer durations based on a terminal identifier of the zero-power-consumption terminal and the number of the multiple candidate timer durations; or the timer duration of the second timer is determined by the zero-power-consumption terminal as a default duration.

In some embodiments, the apparatus includes a second transmission module 640, configured to transmit the instruction information; the instruction information is configured to instruct information related to the second timer.

In some embodiments, the instruction information includes at least one of a starting instruction of the second timer; and a timer duration of the second timer.

In some embodiments, the apparatus includes a third transmission module 650, configured to transmit configuration information; the configuration information is configured to configure the priority.

It should be noted that when the apparatus provided in the above embodiments implements its functions, only the above division of each functional module is taken as an example. In a practical application, the above functional allocation may be completed by different functional modules according to a practical need, that is, the content structure of the device is divided into different functional modules to complete all or part of the functions described above.

For the apparatus in the above embodiments, a method of each module to perform operations has been described in detail in the embodiment of the method, and is not described in detail here.

FIG. 17 is a structural schematic diagram of a communication device according to an embodiment of the present disclosure. The communication device may include a processor 801, a receiver 802, a transmitter 803, a memory 804, and a bus 805.

The processor 801 includes one or more processing cores. The processor 801 performs various functional applications and information processing by running software programs and modules.

The receiver 802 and transmitter 803 may be implemented as a transceiver, which may be a communication chip.

The memory 804 is connected to the processor 801 through the bus 805. For example, the processor 801 may be implemented as a first IC chip, and the processor 801 and memory 804 may be jointly implemented as a second IC chip. The first chip or the second chip may be application specific integrated circuit (ASIC) chips.

The memory 804 may be configured to store at least one computer program, and the processor 801 may be configured to execute the at least one computer program to implement the operations in the above method embodiments.

In addition, the memory 804 may be implemented by any type of transitory or non-transitory storage device or their combination. The transitory or non-transitory storage device includes but is not limited to: a random access memory (RAM), a read only memory (ROM), an erasable programmable read-only memory (EPROM), an electrically erasable programmable read-only memory (EEPROM), a flash memory or other solid-state storage technology, a compact disc read-only memory (CD-ROM), a high-density digital video disc (DVD) or other optical storage, a tape cartridge, a tape, a disk storage or other magnetic storage device.

Some embodiments of the present disclosure also provide a computer-readable storage medium storing a computer program. The computer program is configured to be executed by a processor of a multi-link device to implement any one of the above methods.

In some embodiments, the computer-readable storage medium may include: a read-only memory (ROM), a random access memory (RAM), a solid state drive (SSD), or an optical disk, etc. The random access memory may include a resistance random access memory (ReRAM) and a dynamic random access memory (DRAM).

Some embodiments of the present disclosure also provide a chip including a programmable logic circuit and/or a program instruction. When running on a multi-link device, the chip is configured to implement any one of the above methods.

Some embodiments of the present disclosure also provide a computer program product or a computer program, the computer program product or the computer program includes a computer instruction stored in a computer-readable storage medium, and a processor of a multi-link device reads and executes the computer instruction from the computer-readable storage medium to implement any one of the above methods.

It should be understood that the “instruction” mentioned in some embodiments of the present disclosure may be a direct instruction, an indirect instruction, or an association. For example, A instructing B may mean that A instructs B directly, for example, B may be obtained through A. A instructing B may mean that A instructs B indirectly, for example, A instructs C, and B may be obtained through C; A instructing B may also mean that there is an association between A and B.

In the description of some embodiments of the present disclosure, the terms “corresponding” or “correspond” may mean that there is a direct or indirect corresponding relationship between the two, or that there is an association between the two, or that there is a relationship between indicating and being indicated, or configuring and being configured.

In the description of some embodiments of the present disclosure, the “multiple” and “a plurality of” refer to two or more. The term “and/or” in the present disclosure is an association relationship describing the associated objects, which means that there can be three kinds of relationships; for example, A and/or B can mean three situations including: A exists alone, A and B exist simultaneously, and B exists alone. The character “/” in the present disclosure generally indicates that associated objects before and after this character are in an “or” relationship.

In addition, the labels of the operations described in some embodiments only shows a possible performing sequence between operations by example. In some other embodiments, the above operations may also be performed without the label sequence. For example, two operations with different labels are performed at the same time, or two operations with different labels are performed in an opposite sequence to the drawings, which is not limited.

Those skilled in the art should understand that, in the above one or more examples, functions described in embodiments of the present disclosure may be implemented by a hardware, a software, a firmware or any combination thereof. When implemented by the software, the functions may be stored in a computer-readable medium or transmitted as one or more instructions or code on the computer-readable medium. The computer-readable medium includes a computer storage medium and a communication medium. The communication medium includes any medium that facilitates the transfer of computer programs from one place to another. The storage medium may be any available medium that may be stored and read by a general-purpose computer or a dedicated computer.

The foregoing is only some embodiments of the present disclosure, and is not intended to limit the present disclosure. Any modification, equivalent replacement, and improvement, etc. made within the principles of the present disclosure shall be included in the scope of protection of the present disclosure.

What is claimed is:

1. An uplink data transmission method of a zero-power-consumption terminal, comprising:
selecting a first uplink resource from uplink resources configured by a network device, in response to the zero-power-consumption terminal meeting a trigger condition; and
transmitting uplink data to the network device through the first uplink resource.

2. The method as claimed in claim 1, wherein the trigger condition comprises:
a terminal attribute or a terminal configuration of the zero-power-consumption terminal matching a trigger instruction transmitted by the network device; and/or
a self-trigger condition.

3. The method as claimed in claim 2, wherein the terminal attribute or the terminal configuration comprises at least one of:
a service type;
group information; and
a terminal identifier.

4. The method as claimed in claim 2, wherein the self-trigger condition comprises:
an access network of the zero-power-consumption terminal changing;
a geographical location of the zero-power-consumption terminal changing; and
a current time being a periodic trigger time.

5. The method as claimed in claim 1, further comprising:
receiving a broadcast message periodically transmitted by the network device; wherein the broadcast message is configured to configure the uplink resources; or
receiving a trigger message transmitted by the network device; wherein the trigger message is configured to configure the uplink resources; or
receiving a configuration message transmitted by the network device; wherein the configuration message is configured to configure the uplink resources, a time domain position corresponding to the configuration message is later than a time domain position corresponding to the trigger message.

6. The method as claimed in claim 3, further comprising:
receiving a broadcast message periodically transmitted by the network device; wherein the broadcast message is configured to configure the uplink resources.

7. The method as claimed in claim 1, wherein selecting a first uplink resource from uplink resources configured by a network device, comprises:
selecting the first uplink resource based on a terminal identifier of the zero-power-consumption terminal and the number of the uplink resources; or
selecting the first uplink resource from the uplink resources configured by the network device based on a first timer; or
randomly selecting the first uplink resource from the uplink resources configured by the network device.

8. The method as claimed in claim 7, wherein a resource serial number of the first uplink resource is equal to a remainder obtained by the terminal identifier divided by the number of the uplink resources; or
the selecting the first uplink resource from the uplink resources configured by the network device based on a first timer, comprises:
starting a first timer, in response to the trigger condition being met; and
in response to timeout of the first timer, selecting an uplink resource, closest to a timeout time in a time domain, from the uplink resources configured by the network device, and determining the uplink resource closest to the timeout time as the first uplink resource.

9. A communication device, comprising a processor and a memory; wherein the memory stores at least one program, and the processor is configured to execute the at least one program to implement a method, and the method comprises:
selecting a first uplink resource from uplink resources configured by a network device, in response to the zero-power-consumption terminal meeting a trigger condition; and
transmitting uplink data to the network device through the first uplink resource.

10. The communication device as claimed in claim 9, wherein the trigger condition comprises:
a terminal attribute or a terminal configuration of the zero-power-consumption terminal matching a trigger instruction transmitted by the network device; and/or
a self-trigger condition.

11. The communication device as claimed in claim 10, wherein the terminal attribute or the terminal configuration comprises at least one of:
a service type;
group information; and
a terminal identifier.

12. The communication device as claimed in claim 10, wherein the self-trigger condition comprises:
an access network of the zero-power-consumption terminal changing;
a geographical location of the zero-power-consumption terminal changing; and
a current time being a periodic trigger time.

13. The communication device as claimed in claim 9, wherein the method further comprises:
receiving a broadcast message periodically transmitted by the network device; wherein the broadcast message is configured to configure the uplink resources; or
receiving a trigger message transmitted by the network device; wherein the trigger message is configured to configure the uplink resources; or
receiving a configuration message transmitted by the network device; wherein the configuration message is configured to configure the uplink resources, a time domain position corresponding to the configuration message is later than a time domain position corresponding to the trigger message.

14. The communication device as claimed in claim 11, wherein the method further comprises:
receiving a broadcast message periodically transmitted by the network device; wherein the broadcast message is configured to configure the uplink resources.

15. The communication device as claimed in claim 9, wherein selecting a first uplink resource from uplink resources configured by a network device, comprises:
selecting the first uplink resource based on a terminal identifier of the zero-power-consumption terminal and the number of the uplink resources; or
selecting the first uplink resource from the uplink resources configured by the network device based on a first timer; or
randomly selecting the first uplink resource from the uplink resources configured by the network device.

16. The communication device as claimed in claim 15, wherein a resource serial number of the first uplink resource is equal to a remainder obtained by the terminal identifier divided by the number of the uplink resources; or
the selecting the first uplink resource from the uplink resources configured by the network device based on a first timer, comprises:
starting a first timer, in response to the trigger condition being met; and
in response to timeout of the first timer, selecting an uplink resource, closest to a timeout time in a time domain, from the uplink resources configured by the network device, and determining the uplink resource closest to the timeout time as the first uplink resource.

17. A communication device, comprising a processor and a memory; wherein the memory stores at least one program, and the processor is configured to execute the at least one program to implement a method, and the method comprises:
receiving, by a network device, uplink data transmitted by the zero-power-consumption terminal through a first uplink resource;
wherein the first uplink resource is selected from the uplink resources configured by the network device, in response to the zero-power-consumption terminal meeting a trigger condition.

18. The communication device as claimed in claim 17, wherein the trigger condition comprises:
a terminal attribute or a terminal configuration of the zero-power-consumption terminal matching a trigger instruction transmitted by the network device; and/or
a self-trigger condition.

19. The communication device as claimed in claim 18, wherein the terminal attribute or the terminal configuration comprises at least one of:
a service type;
group information; and
a terminal identifier.

20. The communication device as claimed in claim 17, wherein the method further comprises:
periodically transmitting, by the network device, a broadcast message to the zero-power-consumption terminal; wherein the broadcast message is configured to configure the uplink resources; or
transmitting, by the network device, a trigger message to the zero-power-consumption terminal; wherein the trigger message is configured to configure the uplink resources; or
transmitting, by the network device, a configuration message to the zero-power-consumption terminal; wherein the configuration message is configured to configure the uplink resources, a time domain position corresponding to the configuration message is later than a time domain position corresponding to the trigger message.
